(19) United States
(12) Patent Application Publication
(10) Pub. No.: US 2017/0162878 A1
(43) Pub. Date: Jun. 8, 2017

(54) GAS DIFFUSION LAYER FOR FUEL CELL, FUEL CELL, AND FORMATION METHOD FOR GAS DIFFUSION LAYER FOR FUEL CELL

(71) Applicant: Panasonic Intellectual Property Management Co., Ltd., Osaka (JP)

(72) Inventors: SHINICHIRO IMURA, Hyogo (JP); TSUTOMU KAWASHIMA, Nara (JP); MASASHI SHOJI, Kyoto (JP)

(21) Appl. No.: 15/434,116

(22) Filed: Feb. 16, 2017

Related U.S. Application Data
(63) Continuation of application No. PCT/JP2015/003529, filed on Jul. 13, 2015.

(30) Foreign Application Priority Data
Sep. 29, 2014 (JP) 2014-199067

(51) Int. Cl. H01M 4/88; H01M 4/86; H01M 8/1004

(52) U.S. Cl. CPC H01M 4/8807; H01M 8/1004; H01M 4/8626

(57) ABSTRACT

A first porous layer includes a fluid flow path that has a groove-shape and has an opening in one main surface of the first porous layer. A second porous layer is disposed on the other main surface of the first porous layer. A proportion of an area occupied by conductive fibers per unit area in a cross-sectional surface of the first porous layer is smaller than a proportion of an area occupied by conductive fibers per unit area in a cross-sectional surface of the second porous layer. The second porous layer is exposed in a part of a surface of the fluid flow path.

### RELATED APPLICATIONS

This application is a Continuation of International Application No. PCT/JP2015/003529, filed on Jul. 13, 2015, which in turn claims priority from Japanese Patent Application No. 2014-199067, filed on Sep. 29, 2014, the contents of all of which are incorporated herein by reference in their entireties.

### BACKGROUND

1. Technical Field

The present disclosure relates to a gas diffusion layer for a fuel cell, a fuel cell including the gas diffusion layer for a fuel cell, and a formation method for the gas diffusion layer for a fuel cell.

2. Description of the Related Art

A fuel cell is a device that generates electric energy from hydrogen and oxygen, and can achieve a high power generation efficiency. Since the fuel cell directly generates power without involving states as thermal energy or kinetic energy that are involved in the conventional power generation scheme, the fuel cell has main characteristics such as high power generation efficiency with a small size, and less influence to the environment due to less emission of nitrogen compound and other harmful substances, less noise and less vibration. As described above, the fuel cell achieves the effective use of the chemical energy of fuel and has the environmentally friendly characteristic, and thus is expected as an energy supplying system for the twenty-first century. For this reason, the fuel cell has been attracting attention as a promising novel power generation system for use in space, an automobile, and a mobile instrument, and for various kinds of usages ranging from large-scale power generation to small-scale power generation. Accordingly, the technological development of the fuel cell has been fully in progress for practice use.

International Publication No. WO 11/045889 discloses a fuel cell including a catalyst layer, a gas diffusion layer, and a separator that are sequentially stacked on both surfaces of a polymer electrolyte film. The gas diffusion layer of this fuel cell is a conductive carbon sheet including a fluid flow path in a surface of the sheet in contact with the separator.

### SUMMARY

A gas diffusion layer for a fuel cell according to an aspect of the present disclosure includes a first porous layer and a second porous layer. The first porous layer includes a first main surface, a second main surface opposite to the first main surface, and a fluid flow path that has a groove-shape, the fluid flow path having an opening in the first main surface. The second porous layer is disposed so as to face the second main surface. A proportion of an area occupied by conductive fibers per unit area in a cross-sectional surface of the first porous layer is smaller than a proportion of an area occupied by conductive fibers per unit area in a cross-sectional surface of the second porous layer. In addition, the second porous layer is exposed in a part of a surface of the fluid flow path.

Another aspect of the present disclosure is a fuel cell. The fuel cell includes a membrane electrode assembly, an anode gas diffusion layer, and a cathode gas diffusion layer. The membrane electrode assembly includes an electrolyte film, an anode catalyst layer provided on one surface of the electrolyte film, and a cathode catalyst layer provided on the other surface of the electrolyte film. The anode gas diffusion layer is disposed on the membrane electrode assembly at a side of the anode catalyst layer. The cathode gas diffusion layer is disposed on the membrane electrode assembly at a side of the cathode catalyst layer. At least one of the anode gas diffusion layer and the cathode gas diffusion layer is constituted by the gas diffusion layer for a fuel cell according to the above-described aspect.

Another aspect of the present disclosure is a formation method for a gas diffusion layer for a fuel cell. The method includes: heating and pressurizing a first porous sheet and a second porous sheet after laminating the first porous sheet and the second porous sheet; and forming a fluid flow path that has a groove-shape and includes a surface in part of which the second porous sheet is exposed, fluid flow path having an opening in a main surface of the first porous sheet. A proportion of an area occupied by conductive fibers per unit area in a cross-sectional surface of the first porous sheet in which the fluid flow path is formed is smaller than a proportion of an area occupied by conductive fibers per unit area in a cross-sectional surface of the second porous sheet.

The present disclosure can achieve improved drainage performance of a gas diffusion layer for a fuel cell.

### BRIEF DESCRIPTION OF THE DRAWINGS

FIG. 1 is a perspective view schematically illustrating the structure of a fuel cell according to an exemplary embodiment;

FIG. 2 is a schematic sectional view taken along line II-II illustrated in FIG. 1;

FIG. 3 is a sectional view schematically illustrating the structure of a gas diffusion layer for a fuel cell;

FIGS. 4A to 4D are sectional views schematically illustrating processes of a formation method for the gas diffusion layer for a fuel cell according to the exemplary embodiment;

FIGS. 5A and 5B are sectional views schematically illustrating the structure of a fuel cell according to a variation; and

FIGS. 6A and 6B are sectional views schematically illustrating the structure of a fuel cell according to another variation.

### DETAILED DESCRIPTION OF EMBODIMENT

### Exemplary Embodiment

From studies on the above-described fuel cell by the inventors of the present disclosure, it has been found that further improvement can be made on the drainage performance of a gas diffusion layer in the conventional fuel cell.

The present disclosure is achieved based on such finding, and provides a technology to achieve improved drainage performance of a gas diffusion layer for a fuel cell.

An exemplary embodiment of the present disclosure will be described below with reference to the drawings. In all drawings, any identical components are denoted by an identical reference sign, and the duplicate description thereof will be omitted as appropriate. The exemplary embodiment is not intended to limit the disclosure but is merely exemplary, and all characteristics and any combination thereof described in the exemplary embodiment do not necessarily represent essential elements of the disclosure.

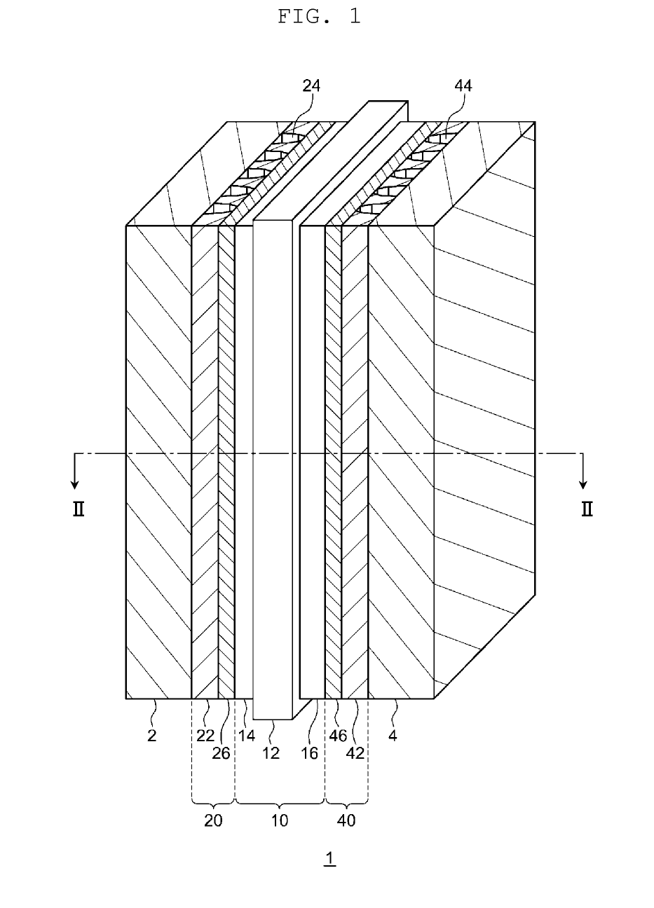

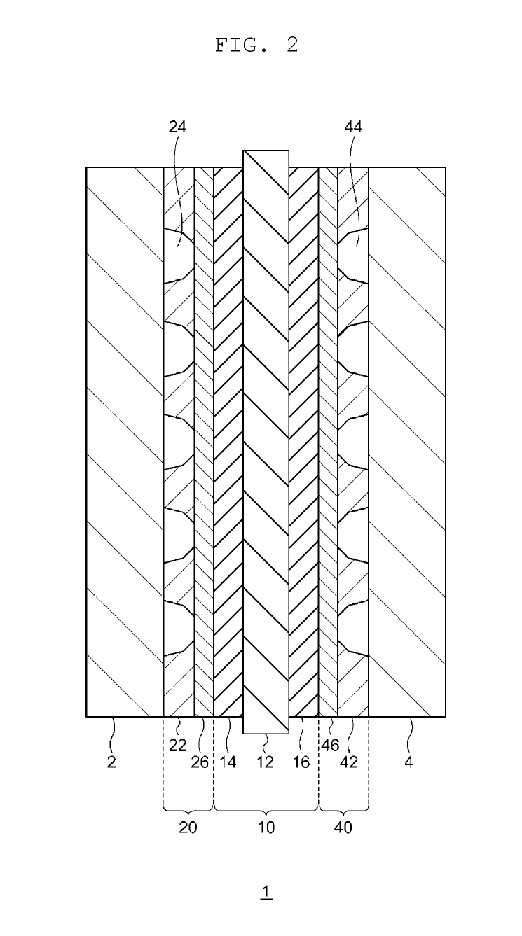

FIG. 1 is a perspective view schematically illustrating the structure of a fuel cell according to the exemplary embodiment. FIG. 2 is a schematic sectional view taken along line II-II illustrated in FIG. 1. Fuel cell 1 according to the present exemplary embodiment includes membrane electrode assembly 10 having a substantially flat plate shape, and anode gas diffusion layer 20 and cathode gas diffusion layer 40 as gas diffusion layers for a fuel cell. Hereinafter, when not needed to be distinguished, anode gas diffusion layer 20 and cathode gas diffusion layer 40 are collectively referred to as the gas diffusion layer for a fuel cell. Anode gas diffusion layer 20 and cathode gas diffusion layer 40 are disposed with membrane electrode assembly 10 interposed between them such that main surfaces of anode gas diffusion layer 20 and cathode gas diffusion layer 40 face each other. Separator 2 is disposed on a main surface of anode gas diffusion layer 20 at a side that is farther from membrane electrode assembly 10. Separator 4 is disposed on a main surface of cathode gas diffusion layer 40 at a side that is farther from membrane electrode assembly 10. In the present exemplary embodiment, description is made on a set of membrane electrode assembly 10, anode gas diffusion layer 20, and cathode gas diffusion layer 40, but a plurality of the sets may be stacked with separators 2 and 4 interposed between the sets, thereby serving as a fuel cell stack.

Membrane electrode assembly 10 includes electrolyte film 12, anode catalyst layer 14, and cathode catalyst layer 16. Anode catalyst layer 14 is disposed on a surface of electrolyte film 12 at one side, and cathode catalyst layer 16 is disposed on a surface of electrolyte film 12 at the other side.

Electrolyte film 12 has favorable ion conductivity in a wet state, and serves as an ion exchange membrane that allows protons to move between anode catalyst layer 14 and cathode catalyst layer 16. Electrolyte film 12 is formed of a solid polymer material such as fluorine-containing polymer or non-fluorine polymer. Examples of the material of electrolyte film 12 include sulfonic acid type perfluorocarbon polymer, polysulfone resin, and perfluorocarbon polymer including phosphonate group, or carboxylic acid group. Examples of sulfonic acid type perfluorocarbon polymer include Nafion (manufactured by Du Pont; registered trademark) 112. Examples of non-fluorine polymer include sulfonated aromatic polyether ether ketone and polysulfone. Electrolyte film 12 has a thickness of, for example, 10 μm to 200 μm inclusive.

Anode catalyst layer 14 and cathode catalyst layer 16 each include ion exchange resin and a catalyst particle, and in some cases include carbon particle that supports catalyst particle. The ion exchange resin included in anode catalyst layer 14 and cathode catalyst layer 16 connects the catalyst particle and electrolyte film 12 to transfer a proton between the catalyst particle and electrolyte film 12. The ion exchange resin may be formed of a polymer material similarly to the polymer material of electrolyte film 12. Examples of the catalyst particle include catalyst metals such as alloys or single materials selected from a group consisting Sc, Y, Ti, Zr, V, Nb, Fe, Co, Ni, Ru, Rh, Pd, Pt, Os, Ir, lanthanoid series elements, and actinoid series elements. The carbon particle may be, for example, acetylene black, Ketjen black, or carbon nano tube. Anode catalyst layer 14 and cathode catalyst layer 16 each has a thickness of, for example, 10 μm to 40 μm inclusive.

Anode gas diffusion layer 20 is disposed on membrane electrode assembly 10 at a side of anode catalyst layer 14. Anode gas diffusion layer 20 includes first porous layer 22, fluid flow path 24, and second porous layer 26. Anode gas diffusion layer 20 has a thickness of, for example, 50 μm to 500 μm inclusive.

FIG. 3 is a sectional view schematically illustrating the structure of the gas diffusion layer for a fuel cell. First porous layer 22 contains a plurality of conductive particles, and binder resin that binds these conductive particles. In FIG. 3, the conductive particles and the binder resin are not separately illustrated, but are illustrated in a mixed state.

The conductive particles may be, for example, carbon particles of carbon black, artificial graphite, natural graphite, or expanded graphite, or metal particles. The conductive particles have an average particle diameter of, for example, 0.01 μm to 50 μm inclusive for primary particles. The binder resin may be fluorine resin such as PTFE (polytetrafluoro ethylene), PFA (tetrafluoro ethylene-perfluoro aklyl vinyl ether copolymer), FEP (tetrafluoro ethylene-hexafluoropropylene copolymer), or ETFE (tetrafluoro ethylene-ethylene copolymer). First porous layer 22 has a thickness of, for example, 30 μm to 300 μm inclusive.

Second porous layer 26 is disposed on a main surface of first porous layer 22 on the other side, in other words, second porous layer 26 is disposed on the main surface at a side closer to anode catalyst layer 14. Second porous layer 26 contains a plurality of conductive fibers 28 each having a length of not shorter than 30 μm, and thermoplastic resin 30. Conductive fibers 28 may be, for example, carbon fibers such as polyacrylonitrile carbon fibers, rayon carbon fibers, pitch carbon fibers, or carbon nano tubes, or metal fibers. The number of bonding points at which conductive fibers 28 bond to each other increases or decreases by changing the kinds and compositions of conductive fibers 28 each having a length of not shorter than 30 μm and the kinds and compositions of thermoplastic resin 30. Thus, the air permeability of second porous layer 26 can be controlled within a wide range. This allows second porous layer 26 to have desired drainage performance. Second porous layer 26 has a thickness of, for example, 20 μm to 200 μm inclusive.

First porous layer 22 may contain conductive fibers 28 contained in second porous layer 26, but an amount of conductive fibers 28 contained in first porous layer 22 is smaller than an amount of conductive fibers 28 contained in second porous layer 26. For example, a proportion of an area occupied by conductive fibers 28 per unit area in a cross-sectional surface of first porous layer 22 is smaller than a proportion of an area occupied by conductive fibers 28 per unit area in a cross-sectional surface of second porous layer 26. The proportion of an area occupied by conductive fibers 28 can be calculated as described below. Specifically, first, an image of a cross-sectional surface of second porous layer 26 is captured by using a scanning electron microscope (SEM). Then, a measurement for the area of conductive fibers 28 per unit area in the cross-sectional surface is performed on the obtained SEM image. The area of conductive fibers 28 is measured by detecting a needle-shaped fiber through the image processing. Then, the ratio of the area of conductive fibers 28 with respect to unit area of the cross-sectional surface is calculated to obtain the proportion of an area occupied by conductive fibers 28. The SEM image has a magnification of, for example, 100 times, and a measured region in the SEM image captured at the magnification has a dimension of 1000 μm×1000 μm.

Since the proportion of an area occupied by conductive fibers 28 in second porous layer 26 is greater than the proportion of an area occupied by conductive fibers 28 in first porous layer 22, it can be realized that second porous layer 26 has a relatively high air permeability and first porous layer 22 has a relatively low air permeability by controlling the air permeability of second porous layer 26 within a wide range. In other words, second porous layer 26 has air permeability higher than that of first porous layer 22.

Fluid flow path 24 has a groove-shape, and has an opening in a main surface of first porous layer 22 at one side. Fluid flow path 24 is provided in first porous layer 22 on a side of the separator 2, and serves as a flow path for fuel gas. Fuel gas such as hydrogen gas is distributed into fluid flow path 24 through a fuel supply manifold (not illustrated), and is supplied from fluid flow path 24 to anode catalyst layer 14 of membrane electrode assembly 10 through first porous layer 22 and second porous layer 26.

Surfaces of fluid flow path 24 include first surface 80, second surface 82, third surface 84, fourth surface 86, and fifth surface 88. First surface 80 is provided in first porous layer 22, extending from the main surface of first porous layer 22 on the one side. Fifth surface 88 is provided facing to first surface 80. First surface 80 and fifth surface 88 are tilted relative to an axis (hereinafter referred to as a “perpendicular axis”) perpendicular to the main surface of first porous layer 22 on the one side so that the distance between first surface 80 and fifth surface 88 is smaller at a position farther away from the main surface of first porous layer 22 on the one side.

Second surface 82 is provided in first porous layer 22 continuously from first surface 80, extending to second porous layer 26. Fourth surface 86 is provided facing to second surface 82. Similarly to first surface 80 and fifth surface 88, second surface 82 and fourth surface 86 are tilted relative to the perpendicular axis, but the angle of the tilt of second surface 82 and fourth surface 86 is different from the angle of the tilt of first surface 80 and fifth surface 88. Third surface 84 is provided on a surface of second porous layer 26, and has a width between a position at which second surface 82 and second porous layer 26 are in contact with each other and a position at which fourth surface 86 and second porous layer 26 are in contact with each other. With such a configuration, second porous layer 26 is exposed on third surface 84 as part of a surface of fluid flow path 24.

Fluid flow path 24 is mainly formed in first porous layer 22. First porous layer 22 contains almost no conductive fibers 28 and contains the conductive particles and the binder resin, thereby having a high formability. This allows easy formation of fluid flow path 24.

Conductive fibers 28 included in second porous layer 26 are disposed such that long axes of conductive fibers 28 are tilted closer to a direction along a main surface of electrolyte film 12 than to a direction perpendicular to the main surface of electrolyte film 12. Accordingly, second porous layer 26 has improved conductivity in the direction along the main surface of electrolyte film 12. The improvement in the conductivity corresponds to reduction in resistance. Since first porous layer 22 is placed over second porous layer 26, a part of first porous layer 22 is provided into second porous layer 26. Consequently, a number of contact points between first porous layer 22 and second porous layer 26 increases, and thus the resistance become smaller than that in a case where second porous layers 26 is placed over second porous layer 26.

In addition, as illustrated in FIG. 3, a projected area of first region 90 that is an overlapping part of first porous layer 22 and second porous layer 26 is larger than a projected area of second region 92 that is a part in which second porous layer 26 is exposed, when the projected area is obtained by projecting in a direction perpendicular to the main surface of first porous layer 22 on the one side. Second region 92 corresponds to third surface 84 described above. Since the projected area of first region 90 is larger than the projected area of second region 92, decrease in a contact area between first porous layer 22 and second porous layer 26 due to second region 92 is suppressed, and thus increase in the resistance between first porous layer 22 and second porous layer 26 is suppressed.

When a width of fluid flow path 24 becomes large, moving path of becomes longer, and thus the resistance increases. Contrary to this, when a width of fluid flow path 24 becomes short, gas pressure drop becomes large, and thus gas does not flow easily. For this reason, fluid flow path 24 has, for example, a depth of 500 μm to 1000 μm inclusive and a width of 0.1 mm to 0.5 mm inclusive, and the distance between adjacent fluid flow paths 24 is 500 μm to 1000 μm inclusive. When a width of second region 92 becomes large, the contact area between first porous layer 22 and second porous layer 26 becomes small, and thus the resistance increases. Contrary to this, when a width of second region 92 becomes short, drainage performance (described later) through fluid flow path 44 degrades. For this reason, second region 92 preferably has a width of 0.02 mm to 0.05 mm inclusive. In the present exemplary embodiment, five fluid flow paths 24 are provided, but the number of fluid flow paths 24 is not particularly limited and may be set as appropriate in accordance with, for example, the dimension of anode gas diffusion layer 20.

Cathode gas diffusion layer 40 is disposed on membrane electrode assembly 10 at a side of cathode catalyst layer 16. Cathode gas diffusion layer 40 includes first porous layer 42, fluid flow path 44, and second porous layer 46. Cathode gas diffusion layer 40 has a thickness of, for example, 50 μm to 500 μm inclusive.

First porous layer 42 contains a plurality of conductive particles and binder resin that binds these conductive particles. The conductive particles and the binder resin may be same as the conductive particles and the binder resin used in first porous layer 22. The composition and dimension of first porous layer 42 are same as the composition and dimension of first porous layer 22.

Second porous layer 46 is disposed on a main surface of first porous layer 42 on the other side, in other words, second porous layer 46 is disposed on the main surface a side closer to cathode catalyst layer 16. Second porous layer 46 contains a plurality of conductive fibers 48 each having a length of not shorter than 30 μm, and thermoplastic resin 50. Conductive fibers 48 and thermoplastic resin 50 may be same as conductive fibers 28 and thermoplastic resin 30 contained in anode gas diffusion layer 20. The composition and dimension of second porous layer 46 are same as the composition and dimension of second porous layer 26. A proportion of an area occupied by conductive fibers 48 per unit area in a cross-sectional surface of first porous layer 42 is smaller than a proportion of an area occupied by conductive fibers 48 per unit area in a section of second porous layer 46. Second porous layer 46 has an air permeability higher than the air permeability of first porous layer 42.

Fluid flow path 44 has a groove-shape, and is provided in a main surface of first porous layer 42 on the one side. Fluid flow path 44 has a configuration same as the configuration of fluid flow path 24. Fluid flow path 44 serves as a flow path for oxidant gas. Fluid flow path 44 also serves as a drainage path for water generated in cathode catalyst layer 16. Oxidant gas such as air is distributed into fluid flow path 44 through an oxidant supply manifold (not illustrated). Then, the oxidant gas is supplied from fluid flow path 44 to cathode catalyst layer 16 of membrane electrode assembly 10 through second porous layer 46. The oxidant gas is also supplied from fluid flow path 44 to cathode catalyst layer 16 of membrane electrode assembly 10 through first porous layer 42 and then through second porous layer 46. With this configuration, the oxidant gas is sufficiently supplied not only to a second part of cathode catalyst layer 16 overlapping the exposed surface (in other words, third surface 84) of second porous layer 46 exposed from first porous layer 42, but also to a first part of cathode catalyst layer 16 overlapping first porous layer 42, when projection is made from the main surface of first porous layer 42 on the one side. Fluid flow path 44 has a dimension same as the dimension of fluid flow path 24.

Second porous layer 46 has air permeability higher than that of first porous layer 42, and thus water generated in cathode catalyst layer 16 by electrochemical reaction or water moved from electrolyte film 12 to cathode catalyst layer 16 can easily pass through second porous layer 46. Accordingly, second porous layer 46 achieves drainage performance higher than that of first porous layer 42. Since second porous layer 46 is disposed closer to cathode catalyst layer 16 compared to first porous layer 42, drainage performance near cathode catalyst layer 16 is improved. When the drainage performance near cathode catalyst layer 16 is improved, the amount of water near cathode catalyst layer 16 decreases, and thus gas diffusion property is improved. Since second porous layer 46 is exposed on third surface 84, water from cathode catalyst layer 16 is directly ejected to fluid flow path 44, not through first porous layer 42. Consequently, drainage performance is further improved. In the present exemplary embodiment, five fluid flow paths 44 are provided, but the number of fluid flow paths 44 is not particularly limited, but may be set as appropriate in accordance with, for example, the dimension of cathode gas diffusion layer 40.

In some cases, a stacked structure of anode catalyst layer 14 and anode gas diffusion layer 20 is referred to as an anode, and a stacked structure of cathode catalyst layer 16 and cathode gas diffusion layer 40 is referred to as a cathode.

A reaction described below occurs in solid polymer fuel cell 1 described above. Specifically, when hydrogen gas as fuel gas is supplied to anode catalyst layer 14 through anode gas diffusion layer 20, a reaction represented by Formula (1) below occurs in anode catalyst layer 14, whereby hydrogen is decomposed into protons and electrons. The protons move toward cathode catalyst layer 16 in electrolyte film 12. The electrons move to an external circuit (not illustrated) and flow into cathode catalyst layer 16 from the external circuit. When air as oxidant gas is supplied to cathode catalyst layer 16 through cathode gas diffusion layer 40, a reaction represented by Formula (2) below occurs in cathode catalyst layer 16, oxygen in the air becomes water through reaction with protons and electrons. As a result, electrons flow from an anode toward a cathode in the external circuit, thereby providing electrical power. The reactions that occur in anode catalyst layer 14 and cathode catalyst layer 16 are as follows.

Anode catalyst layer 14: H₂→2H⁺+2e⁻ (1)

Cathode catalyst layer 16: 2H⁺+(1/2)O₂+2e⁻→H₂O (2)

### Process of Manufacturing Gas Diffusion Layer for Fuel Cell

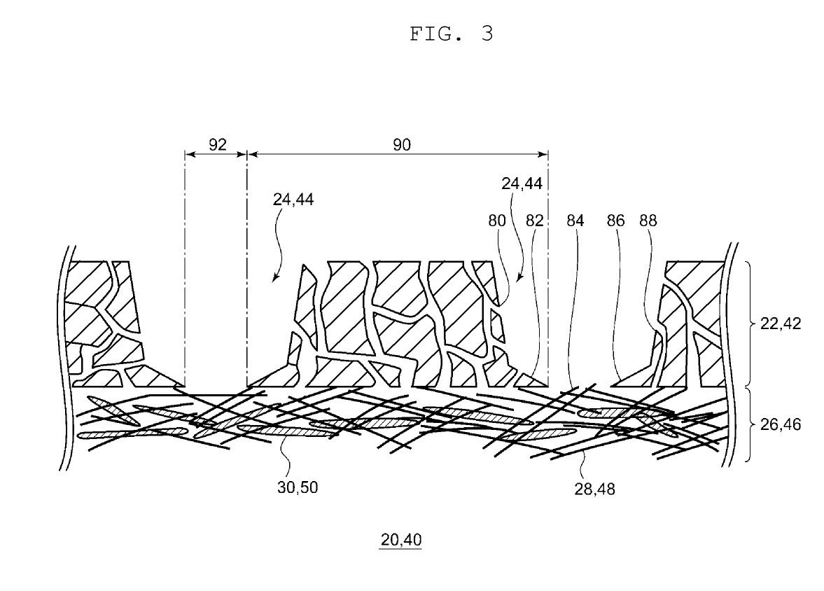

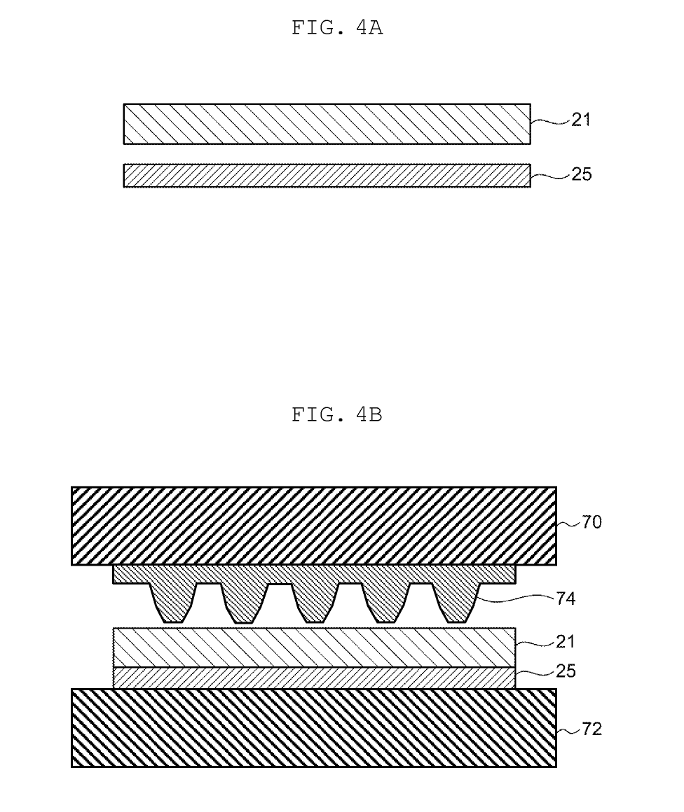

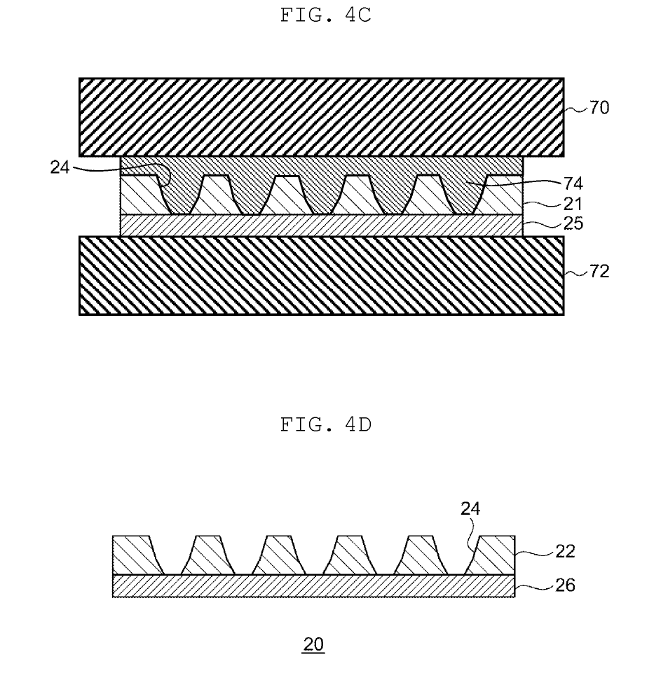

The following describes a formation method for the gas diffusion layer for a fuel cell according to the exemplary embodiment. FIGS. 4A to 4D are sectional views schematically illustrating processes of the formation method for the gas diffusion layer for a fuel cell according to the exemplary embodiment. The description of the manufacturing method for the gas diffusion layer for a fuel cell will be made below on an example with anode gas diffusion layer 20.

First, as illustrated in FIG. 4A, first porous sheet 21 and second porous sheet 25 are prepared. Second porous sheet 25 contains a plurality of conductive fibers 28 (refer to FIG. 3) and thermoplastic resin 30 (refer to FIG. 3). First porous sheet 21 contains a plurality of conductive particles and binder resin, and has a proportion of an area occupied by conductive fibers 28 described above smaller than a proportion of an area occupied by conductive fibers 28 in a section of second porous sheet 25.

Next, as illustrated in FIG. 4B, first porous sheet 21 and second porous sheet 25 are laminated and disposed between first mold 70 and second mold 72. First mold 70 is provided with projection 74 corresponding to the shape of fluid flow path 24. Second mold 72 has a flat surface facing to projection 74.

Next, as illustrated in FIG. 4C, first mold 70 and second mold 72 are moved to make predetermined shape, and then first porous sheet 21 and second porous sheet 25 which are laminated are heated and pressurized at a predetermined temperature and a predetermined pressure. Then, fluid flow path 24 having a groove-shape is formed in a main surface of first porous sheet 21 on the one side. Second porous sheet 25 is exposed in a part of a surface of fluid flow path 24. When thermoplastic resin 30 is made of PTFE, a pressure and a temperature at molding are 10 MPa and 200° C., respectively. Simultaneously with the molding, first porous sheet 21 and second porous sheet 25 are bonded to each other by pressing. After a predetermined time has elapsed, first mold 70 and second mold 72 are released.

As illustrated in FIG. 4D, the above-described process forms anode gas diffusion layer 20 that includes first porous layer 22 including fluid flow path 24 in the main surface of first porous layer 22 on the one side, and second porous layer 26 stacked on the main surface of first porous layer 22 on the other side.

### Variations

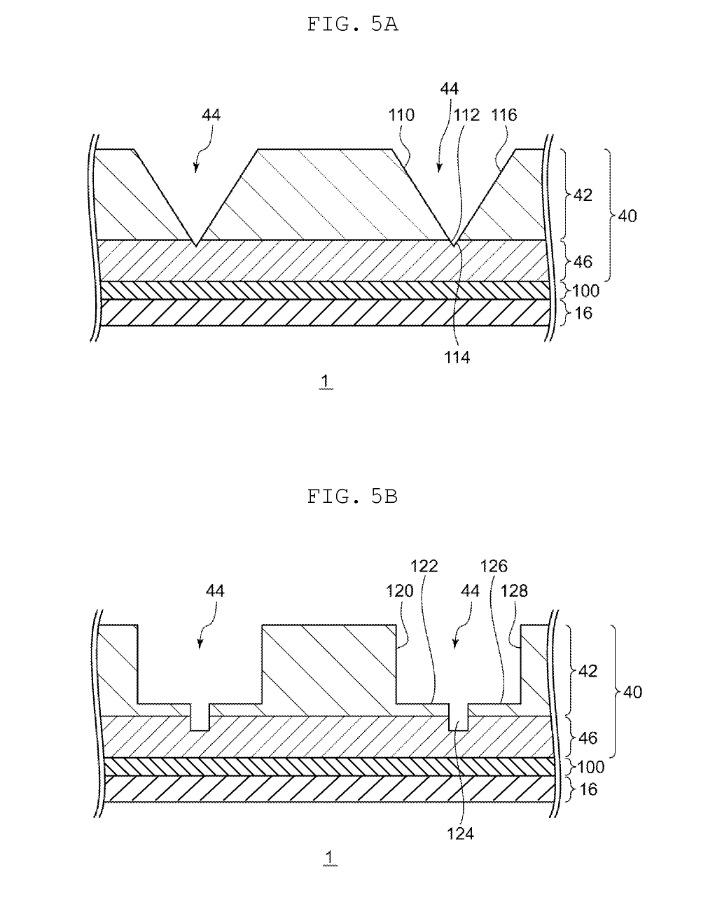

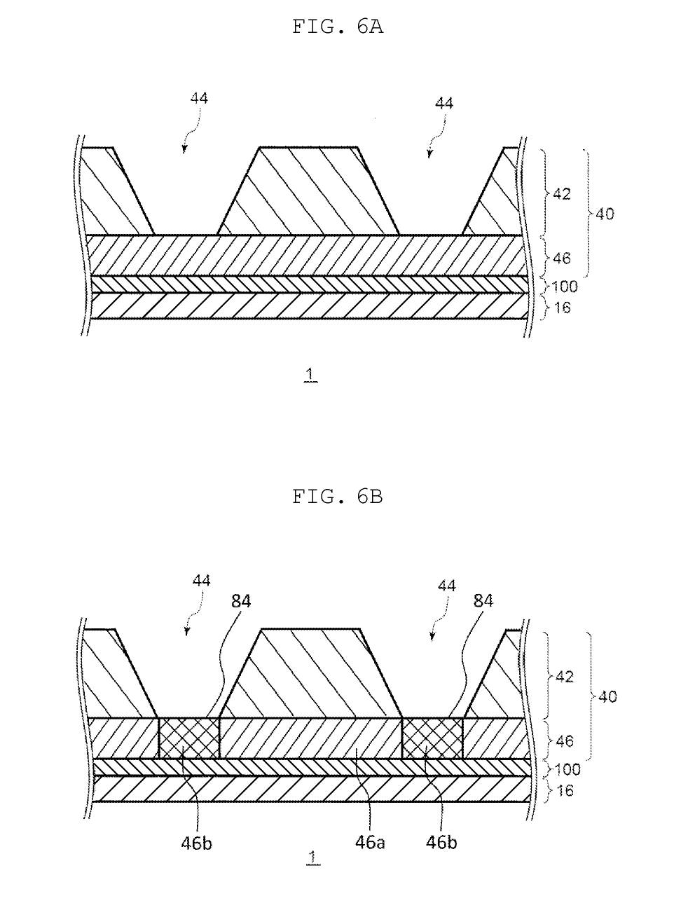

FIGS. 5A and 5B and FIGS. 6A and 6B are each a sectional view schematically illustrating the structure of fuel cell 1 according to a variation. In FIGS. 5A and 5B and FIGS. 6A and 6B, fluid flow path 24 has a different shape or second porous layer 46 has a different property. FIG. 5A illustrates cathode gas diffusion layer 40 and cathode catalyst layer 16. Surfaces of fluid flow path 44 includes first surface 110, second surface 112, third surface 114, and fourth surface 116. First surface 110 is provided extending from the main surface of first porous layer 42 on the one side to second porous layer 46. Fourth surface 116 is provided facing to first surface 110. First surface 110 and fourth surface 116 are tilted relative to the perpendicular axis so that the distance between first surface 110 and fourth surface 116 is smaller at a position farther away from the main surface of first porous layer 42 on the one side.

Second surface 112 is provided in second porous layer 46 continuously from first surface 110, extending from a main surface of second porous layer 46 on the one side. Third surface 114 is provided facing to second surface 112, and is connected with second surface 112 in second porous layer 46. Similarly to first surface 110 and fourth surface 116, second surface 112 and third surface 114 are tilted relative to the perpendicular axis, but the angle of the tilt of second surface 112 and third surface 114 may be same as or different from the angle the tilt of first surface 110 and fourth surface 116. With such a configuration, second porous layer 46 is exposed on second surface 112 and third surface 114 that are part of the surfaces of fluid flow path 44. A groove is formed into second porous layer 46 to form second surface 112 and third surface 114, and thus drainage performance is further improved.

In FIG. 5A, fine porous layer 100 is stacked between second porous layer 46 and cathode catalyst layer 16. Fine porous layer 100 is dense and has a low air permeability and a high water-repellent property, and thus fine porous layer 100 causes water produced in cathode catalyst layer 16 to move to second porous layer 46 in a steam state, not in a liquid state. Accordingly, drainage performance in cathode catalyst layer 16 is further improved.

FIG. 5B illustrates cathode gas diffusion layer 40 and cathode catalyst layer 16. Surfaces of fluid flow path 44 include first surface 120, second surface 122, groove portion 124, third surface 126, and fourth surface 128. First surface 120 is provided in first porous layer 42, extending from the main surface of first porous layer 42 on the one side. Fourth surface 128 is provided facing to first surface 120. First surface 120 and fourth surface 128 are disposed along the perpendicular axis.

Second surface 122 is connected with first surface 120 and provided in substantially parallel to the main surface of first porous layer 42 on the one side. Third surface 126 is connected with fourth surface 128 and provided in substantially parallel to the main surface of first porous layer 42 on the one side. In addition, groove portion 124 is formed into second porous layer 46 from where second surface 122 and third surface 126 is close to each other. With such a configuration, second porous layer 46 is exposed in a part of groove portion 124 that is a part of the surfaces of fluid flow path 44.

FIG. 6A illustrates cathode gas diffusion layer 40 and cathode catalyst layer 16. Since the air permeability of second porous layer 46 can be controlled within a wide range, which it can be realized that first porous layer 42 has a relatively high air permeability and second porous layer 46 has a relatively low air permeability. In FIG. 6A, first porous layer 42 has an air permeability higher than that of second porous layer 46. With such a configuration, similarly to fine porous layer 100, second porous layer 46 can eject water produced in cathode catalyst layer 16 to fluid flow path 44 in a steam state.

FIG. 6B illustrates cathode gas diffusion layer 40 and cathode catalyst layer 16. When projection is made from the main surface of first porous layer 42 on the one side, a water-repellent property for first part 46a of second porous layer 46 which is overlapped by first porous layer 42 is higher than a water-repellent property for second part 46b of second porous layer 46 which is overlapped by the exposed surface (in other words, third surface 84) from first porous layer 42. Water generated in cathode gas diffusion layer 40 is attracted to second part 46b of second porous layer 46, which has a low water-repellent property. Oxidant gas is supplied to cathode catalyst layer 16 through first porous layer 42 and first part 46a of second porous layer 46, which has a high water-repellent property. In addition, surplus oxidant gas flows from first part 46a of second porous layer 46, which has a high water-repellent property, into second part 46b of second porous layer 46, which has a low water-repellent property. Accordingly, the generated water which is attracted to second part 46b of second porous layer 46 is pushed to fluid flow path 44 by the surplus oxidant gas, and then ejected. As described above, fluid flow paths 44 having various shapes and second porous layers 46 having various properties are provided. The shape of fluid flow path 44 and second porous layer 46 provided in cathode gas diffusion layer 40 are described with reference to FIGS. 5A and 5B and FIGS. 6A and 6B, but fluid flow path 24 and second porous layer 26 provided in anode gas diffusion layer 20 may have an identical shape. In addition, fine porous layer 100 is provided in configurations of FIGS. 5A and 5B and FIGS. 6A and 6B, but may be omitted, and fine porous layer 100 may be provided in configurations of FIGS. 1 and 2.

According to the present exemplary embodiment, since a fluid flow path having a groove-shape, which has an opening in the main surface of the first porous layer on the one side and has a small proportion of an area occupied by conductive fibers is provided, the fluid flow path can be easily shaped. The easy shaping of the fluid flow path leads to a simplified process, and thus to reduction in cost. The second porous layer having a large proportion of an area occupied by conductive fibers is disposed on a side of the main surface of the first porous layer on the other side, and thus drainage performance near the catalyst layer is improved. Since drainage performance near the catalyst layer is improved, gas diffusion property is improved. Since the fluid flow path partially penetrates the first porous layer so that the second porous layer is exposed, water generated in the catalyst layer can be ejected to the fluid flow path, avoiding accumulation in the first porous layer. Drainage performance can be improved because water generated in the catalyst layer is ejected to the fluid flow path without accumulation in the first porous layer.

Since the second porous layer having a large proportion of an area occupied by conductive fibers is disposed on a side of the main surface of the first porous layer on the other side, the resistance along the main surface can be reduced by conductive fibers disposed along the main surface. The reduction in the resistance leads to improved conductivity. Since the first porous layer and the second porous layer are laminated, the number of contact points can be increased. The increase in the number of the contact points leads to reduction in the resistance. Since the projected area of the overlapping part of the first porous layer and the second porous layer is larger than the projected area of the part in which the second porous layer is exposed, the resistance can be reduced even when the second porous layer is exposed.

The present disclosure is not limited to the above-described exemplary embodiment, but a variation involving various design changes may be added to the exemplary embodiment based on the knowledge of the skilled person in the art. The exemplary embodiment to which such a variation is added is included in the scope of the present disclosure.

In the exemplary embodiment described above, anode gas diffusion layer 20 and cathode gas diffusion layer 40 include first porous layers 22 and 42, fluid flow paths 24 and 44, and second porous layers 26 and 46, respectively. However, the present disclosure is not particularly limited thereto, but only one of anode gas diffusion layer 20 and cathode gas diffusion layer 40 may include the above-described configuration.

In the exemplary embodiment described above, the process of forming fluid flow path 24 and the process of stacking second porous sheet 25 on first porous sheet 21 are simultaneously performed. Thus, the process of manufacturing the gas diffusion layer for a fuel cell can be simplified as compared to a case in which both processes are performed at different times. However, the present disclosure is not particularly limited to this manufacturing process, but the process of stacking second porous sheet 25 on first porous sheet 21 may be performed before or after the process of forming fluid flow path 24.

When the process of stacking second porous sheet 25 is performed after the process of forming fluid flow path 24, only first porous sheet 21 is first disposed between first mold 70 and second mold 72 and shaped by pressing to form fluid flow path 24. Then, first porous sheet 21 provided with fluid flow path 24, and second porous sheet 25 are placed over each other, disposed between first mold 70 and second mold 72, and shaped by pressing to stack second porous sheet 25 on first porous sheet 21.

When the process of stacking second porous sheet 25 is performed before the process of forming fluid flow path 24, first porous sheet 21 and second porous sheet 25 are first placed over each other, disposed between first mold 70 and second mold 72, and shaped by pressing. At this stage, first mold 70 is flat, not including projection 74. Then, second porous sheet 25 is stacked on first porous sheet 21. Subsequently, the obtained stack is disposed between first mold 70 and second mold 72 and shaped by pressing. At this stage, first mold 70 includes projection 74. Accordingly, fluid flow path 24 is formed in first porous sheet 21.

What is claimed is:

1. A gas diffusion layer for a fuel cell, the gas diffusion layer comprising:
a first porous layer including a first main surface, a second main surface opposite to the first main surface, and a fluid flow path that has a groove-shape, the fluid flow path having an opening in the first main surface; and
a second porous layer disposed so as to face the second main surface, wherein:
a proportion of an area occupied by conductive fibers per unit area in a cross-sectional surface of the first porous layer is smaller than a proportion of an area occupied by conductive fibers per unit area in a cross-sectional surface of the second porous layer,
the second porous layer is exposed in a part of a surface of the fluid flow path, and
the fluid flow path is formed into the second porous layer.

2. The gas diffusion layer for a fuel cell according to claim 1, wherein, a projected area of an overlapping part of the first porous layer and the second porous layer is larger than a projected area of a part in which the second porous layer is exposed, when the projected area is obtained by projecting in a direction perpendicular to the first main surface.

3. A fuel cell comprising:
a membrane electrode assembly including an electrolyte film, a cathode catalyst layer provided on one surface of the electrolyte film, and an anode catalyst layer provided on the other surface of the electrolyte film;
an anode gas diffusion layer disposed on the membrane electrode assembly at a side of the anode catalyst layer; and
a cathode gas diffusion layer disposed on the membrane electrode assembly at a side of the cathode catalyst layer,
wherein at least one of the anode gas diffusion layer and the cathode gas diffusion layer is constituted by the gas diffusion layer for a fuel cell according to claim 1.

4. A formation method for a gas diffusion layer for a fuel cell, the formation method comprising:
heating and pressurizing a first porous sheet and a second porous sheet after laminating the first porous sheet and the second porous sheet; and
forming a fluid flow path that has a groove-shape and includes a surface in part of which the second porous sheet is exposed, fluid flow path having an opening in a main surface of the first porous sheet,
wherein a proportion of an area occupied by conductive fibers per unit area in a cross-sectional surface of the first porous sheet in which the fluid flow path is formed is smaller than a proportion of an area occupied by conductive fibers per unit area in a cross-sectional surface of the second porous sheet.
